(19) United States
(12) Patent Application Publication
(10) Pub. No.: US 2004/0080469 A1
(43) Pub. Date: Apr. 29, 2004

(54) Image display apparatus

(76) Inventors: Hirotaka Murata, Fukaya-Shi (JP); Takashi Nishimura, Fukaya-Shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/687,747

(22) Filed: Oct. 20, 2003

Related U.S. Application Data
(63) Continuation of application No. PCT/JP02/03914, filed on Apr. 19, 2002.

(30) Foreign Application Priority Data
Apr. 20, 2001 (JP) 2001-122557

(51) Int. Cl. G09G 3/22

(52) U.S. Cl. 345/75.2

(57) ABSTRACT

A vacuum envelope of an image display apparatus includes a rear substrate and a front substrate opposed to each other and a sidewall interposed between the rear substrate and the front substrate. An image display surface is formed on an inner surface of the front substrate, and a large number of electron emitting elements that emit electrons toward the image display surface are arranged on an inner surface of the rear substrate. A grid is located between the rear substrate and the front substrate and fixed to the rear substrate. The grid has a thermal expansion coefficient higher than that of the rear substrate.

### CROSS-REFERENCE TO RELATED APPLICATIONS

This is a Continuation Application of PCT Application No. PCT/JP02/03914, filed Apr. 19, 2002, which was not published under PCT Article 21(2) in English.

This application is based upon and claims the benefit of priority from the prior Japanese Patent Application No. 2001-122557, filed Apr. 20, 2001, the entire contents of which are incorporated herein by reference.

### BACKGROUND OF THE INVENTION

1. Field of the Invention

The present invention relates to an image display apparatus, and more particularly, to an image display apparatus having a large number of electron emitting elements.

2. Description of the Related Art

Recently, there has been a demand for image display apparatuses for high-definition broadcasting or their corresponding high-resolution image display apparatuses, and their screen display performance is subject to stricter requirements. To meet these requirements, it is essential to flatten their screen and increase its resolution. At the same time, the apparatus must be reduced in weight and thickness.

As a next generation of an image display apparatus that fulfills these requirements, an image display apparatus is being developed in which a large number of electron emitting elements (hereinafter referred to as emitters) are arranged side by side and opposed to a phosphor surface. The emitters may be supposed to be of the field-emission type or surface-conduction type. Usually, an image display apparatus that uses electron emitting elements of the field-emission type as the emitters is called a field emission display (hereinafter referred to as FED). An image display apparatus that uses electron emitting elements of the surface-conduction type as the emitters is called a surface-conduction electron emission display (hereinafter referred to as SED).

In general, the FED, for example, has a front substrate and a rear substrate that are opposed to each other with a given gap between them. These substrates have their respective peripheral edge portions bonded together by a sidewall in the form of a rectangular frame, thereby constituting a vacuum envelope. A phosphor screen is formed on the inner surface of the front substrate. A large number of emitters for use as sources of electron emission for exciting phosphors to luminescence are provided on the inner surface of the rear substrate.

A plate-like grid is arranged between the two substrates. The grid is formed having a large number of apertures that are aligned with the emitters, individually. In order to support atmospheric pressure that acts on the rear substrate and the front substrate, moreover, a plurality of support members are arranged between these substrates. At least a part or parts of the grid and the support members are bonded to the rear substrate or the front substrate.

In the FED constructed in this manner, electron beams emitted from the emitters are applied to desired phosphor layers through their corresponding apertures of the grid, whereupon the phosphors are caused to glow to display an image.

In the FED of this type, each emitter has a micrometer-order size, and the gap between the front substrate and the rear substrate can be adjusted to the millimeter order. Therefore, the FED can enjoy higher resolution and be made lighter in weight and thinner than a cathode ray tube (CRT) that is used as a display of an existing TV set or computer.

In manufacturing processes for the image display apparatus constructed in this manner, the rear substrate, to which structures such as the grid and the support members are bonded in advance, and the front substrate are baked at 300° C. or more for degassing. In bonding the rear substrate and the front substrate together by the sidewall, the rear substrate and the front substrate are externally heated by a heater. Thus, in these manufacturing processes, the rear substrate, to which the grid and other structures are fixed, and the front substrate become hotter than these structures.

As mentioned before, moreover, the many emitters on the rear substrate generate heat as they emit electrons toward the phosphor layers during the operation of the image display apparatus. Accordingly, the temperature of the rear substrate increases so that it easily becomes hotter than the grid.

Thus, during the manufacture or operation of the image display apparatus, the rear substrate and the front substrate become hotter than the structures that are fixed to the substrates. In some cases, a temperature difference of tens of degrees may be caused between the rear substrate and the structures. If the temperature difference causes a difference in thermal expansion between the rear substrate and the structures fixed thereon, and if the thermal expansion of the rear substrate is greater than that of the structures, in particular, tensile force acts on the structures. Possibly, therefore, the structures and the rear substrate may be disengaged from one another.

Thus, in this case, the image display apparatus is subject to manufacturing failure, so that the yield of production lowers, and the reliability of operation lowers.

### BRIEF SUMMARY OF THE INVENTION

The present invention has been contrived in consideration of these circumstances, and its object is to provide an image display apparatus in which separation or breakage of joints that is attributable to a difference in temperature can be prevented, so that manufacturing failure can be reduced and reliability can be improved.

In order to achieve the above object, an image display apparatus according to an aspect of the present invention comprises a vacuum envelope having a first substrate and a second substrate opposed to each other with a gap, a structure located between the first substrate and the second substrate and fixed to at least one of the substrates, an image display surface formed on an inner surface of one of the first and second substrates, and a plurality of electron emitting elements which are arranged on an inner surface of the other of the first and second substrates and emit electrons toward the image display surface, the structure having a thermal expansion coefficient higher than that of the at least one substrate to which the structure is fixed.

According to the image display apparatus according to the aspect of this invention, moreover, the structure includes a plate-like grid located between the first substrate and the second substrate and opposed to the first and second substrates and/or a plurality of support members which are arranged between the first substrate and the second substrate and support the first and second substrates against the atmospheric pressure.

According to the image display apparatus constructed in this manner, the structure has a thermal expansion coefficient higher than that of the one substrate to which the structure is fixed. Even if the temperature of the one substrate becomes higher than that of the structure during manufacture or operation, therefore, the thermal expansion of the one substrate can never become greater than the thermal expansion of the structure. Accordingly, no tensile force can be generated in the structure, so that the joint between the structure and the substrate can be prevented from being separated or damaged.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a perspective view showing an SED according to an embodiment of this invention;

FIG. 2 is an enlarged plan view showing a joint between a grid and a rear substrate of the SED;

FIG. 3 is a sectional view taken along line A-A of FIG. 1;

FIG. 4 is an enlarged perspective view showing the principal part of the SED; and

FIG. 5 is a graph comparatively showing the respective thermal expansion characteristics of the grid and the rear substrate of the SED.

### DETAILED DESCRIPTION OF THE INVENTION

An embodiment of this invention that is applied to an SED will now be described in detail with reference to the drawings.

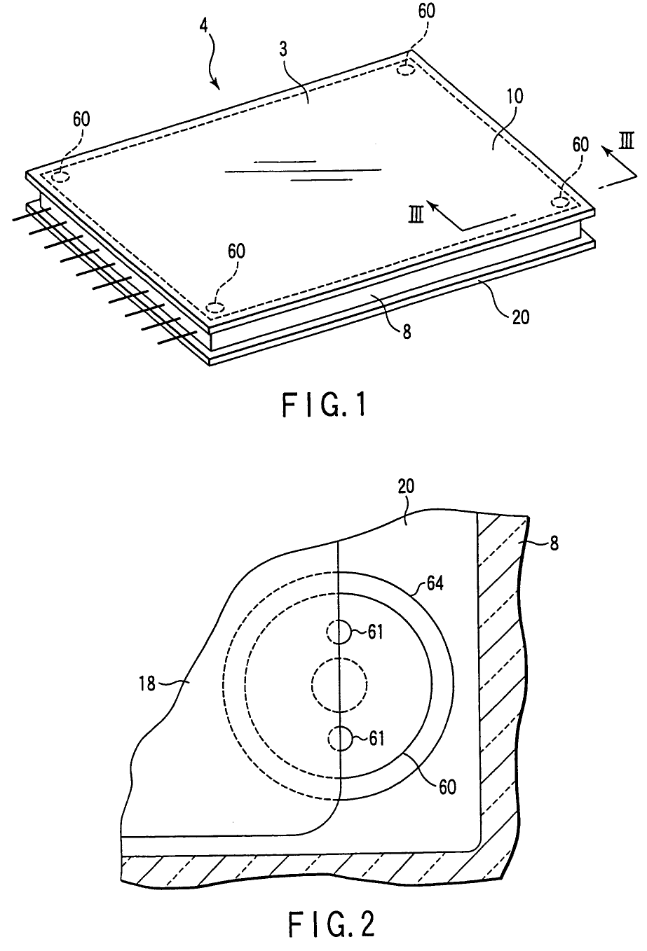

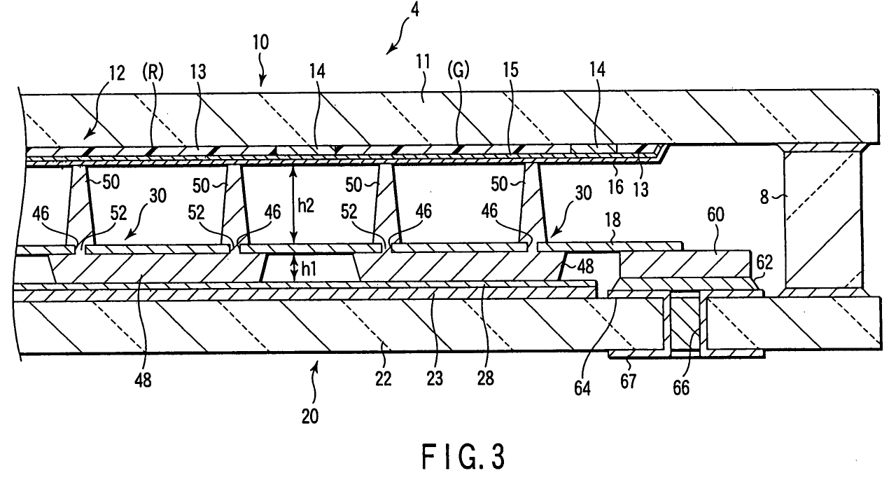

As shown in FIGS. 1 and 3, the SED comprises an effective display region 3 having an aspect ratio of 4:3 and diagonal dimension of 36 inches. This SED has a rectangular front substrate 10 and a rear substrate 20 that are opposed to each other with a given gap between them. The front substrate 10 and the rear substrate 20 have their respective peripheral edge portions joined together through a frame-shaped sidewall 8 of a glass material, and constitute a vacuum envelope 4. The sidewall 8 is bonded to the front substrate 10 and the rear substrate 20 by a frit glass, or a low-melting metal or alloy, such as indium. A high vacuum of, e.g., about 10⁻⁶ Pa is maintained in the internal space of the vacuum envelope 4.

A grid 18 in the form of a rectangular plate is interposed between the front substrate 10 and the rear substrate 12. It is connected to a given potential in order to prevent abnormal discharge between the substrates, and is opposed to the effective display region 3. Further, the front substrate 10 and the rear substrate 12 are supported against the atmospheric pressure by means of a plurality of spacers 30 that are arranged between the substrates. A space of, e.g., 1.5 to 2.0 mm is maintained between them.

As shown in FIG. 3, the front substrate 10, which functions as a first substrate, is provided with an insulating substrate 11 formed of a non-alkali glass and a phosphor screen 12 formed on the inner surface of the insulating substrate. The phosphor screen 12, which functions as an image display surface and a phosphor surface, has stripe-shaped phosphor layers 13 and belt-shaped light shielding layers 14. The phosphor layers 13 have luminous characteristics such that they glow red (R), blue (B), and green (G), individually, and are arranged at given pitches. The light shielding layers 14 are arranged between the phosphor layers 13 and serve to improve the contrast.

An electrically conductive thin film 15 of aluminum or its alloy is formed on the phosphor screen 12. Further, a deposited getter layer 16 of barium (Ba) is formed on the conductive thin film 15. The conductive thin film 15 functions as an anode. The deposited getter layer 16 is formed by depositing a getter material in a vacuum chamber before joining the front substrate 10 and the rear substrate 20 together in the vacuum chamber during the manufacture of the SED. The high-performance deposited getter layer 16 can be obtained in a manner such that a series of processes from the vapor deposition of the getter material to sealing is carried out in a vacuum atmosphere without exposing the getter material to the atmosphere.

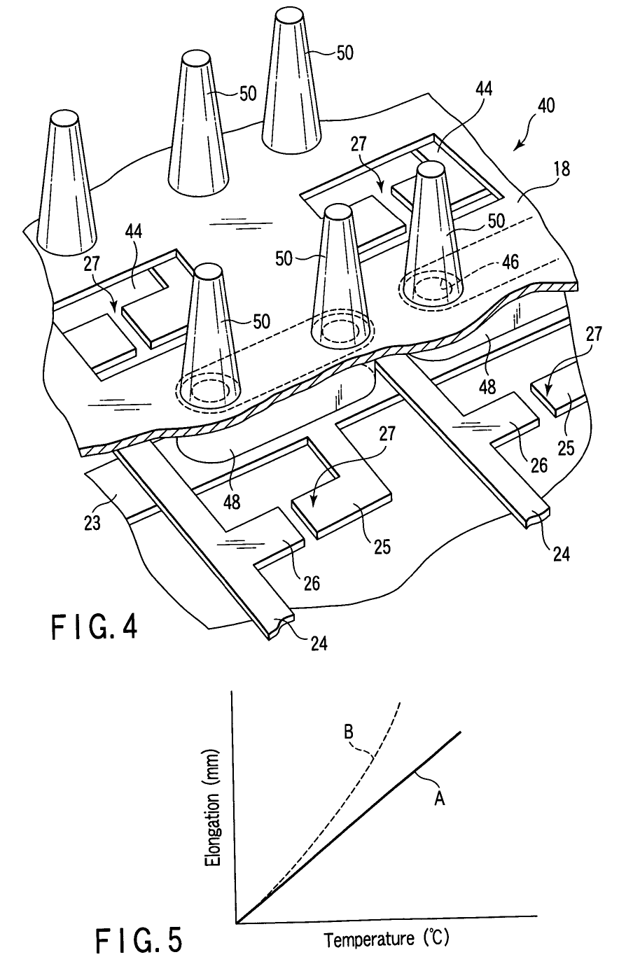

As shown in FIGS. 3 and 4, the rear substrate 20, which functions as a second substrate, is provided with an insulating substrate 22 formed of a non-alkali glass. A plurality of scanning electrodes 23 and signal electrodes 24 are arranged in a matrix on the inner surface of the insulating substrate 22. Gate electrodes 25 and emitter electrodes 26 that extend from the scanning electrodes 23 and the signal electrodes 24, respectively, are provided near the intersections of the scanning electrodes and the signal electrodes. The gate electrodes 25 and the emitter electrodes 26 are opposed to one another at given spaces, individually. Further, graphite films (not shown), for example, are opposed to one another at spaces of 5 nm between the electrodes 25 and 26, thus forming electron emitting elements 27 of the surface-conduction type. A protective film 28 is formed on each scanning electrode 23.

The grid 18, which is located between the front substrate 10 and the rear substrate 20 constructed in this manner, is in the form of a rectangle that is substantially as large as the effective display region 3. As shown in FIGS. 1 and 3, moreover, the four corner portions of the grid 18 are fixed to the rear substrate 20 by means of pedestals 60, individually.

As shown in FIGS. 2 and 3, each pedestal 60 is in the form of a disc, which is fixed on the insulating substrate 22 of the rear substrate 20 by electrically conductive frit glass 62 and silver paste 64. For example, a side edge of each corner portion of the grid 18 is welded to the upper surface of each corresponding pedestal 60 at two welding points 61. A through hole 66 is formed in that part of the insulating substrate 22 which faces one of the pedestals 60. This pedestal 60 is connected electrically to a power supply terminal 67, that is formed on the outer surface of the insulating substrate 22, through the through hole 66. Thus, a given grid potential can be supplied to the grid 18 through the through hole 66 and the pedestal 60.

The grid 18 is formed of a material that has a thermal expansion coefficient higher than that of the insulating substrate 22 of the rear substrate 20 to which the grid is fixed. For example, the grid 18 is formed of an iron-nickel alloy of 0.1 mm thickness, and its surface is oxidized. The thermal expansion coefficient of the glass that constitutes the insulating substrate 22 is 84×10⁻⁷/K, while the thermal expansion coefficient of the grid 18 is 94×10⁻⁷/K.

FIG. 5 comparatively shows a thermal expansion characteristic B of the grid 18 and a thermal expansion characteristic A of the glass that constitutes the insulating substrate 22. The grid 18 has a thermal expansion characteristic such that its elongation rate is higher than that of the insulating substrate 22 at any temperature.

As shown in FIGS. 3 and 4, the grid 18 has rectangular apertures 44 through which electron beams emitted from the electron emitting elements 27 are passed, individually. The apertures 44 face the electron emitting elements 27, individually. Further, the grid 18 is formed having a plurality of circular openings 46 for the connection of first and second spacers, which will be mentioned later.

The spacers 30 that function as support members are formed integrally with the grid 18. More specifically, the grid 18 has a first principal surface that faces the rear substrate 20 and a second principal surface that faces the front substrate 10. A plurality of first spacers 48 are formed integrally with the grid 18 on the first principal surface side, while a plurality of second spacers 50 are formed integrally with the grid 18 on the second principal surface side. The first spacers 48 and the second spacers 50 are coupled to one another by junctions 52 in the openings 46 of the grid 18. In the present embodiment, two second spacers 50 are coupled to each first spacer 48 by one junction 52, thus constituting each spacer 30.

The first spacers 48 are arranged on each scanning electrode 23 with the protective film 28 between them, and extend in the extending direction of the scanning electrode. Each first spacer 48 has an oblong cross section and a height h1 of 0.5 mm.

Each of two second spacers 50 that are provided for each first spacer 48 is in the form of a slightly tapered column having a height h2 of 1.0 mm. Thus, each second spacer 50 has an aspect ratio (ratio between the length of the second spacer in the direction of the major axis of its cross section at the end on the side of the grid 18 and the height of the second spacer) high enough for the first spacer 48. Each two adjacent second spacers 50 are coupled to one first spacer 48 through the openings 46 of the grid 18 or the junctions 52, and are integral with the first spacer 48 and the grid 18.

When the grid 18 that is provided integrally with the spacers 30 constructed in this manner is located in the vacuum envelope 4, the first spacers 48 abut against the rear substrate 10 through the protective film 28 and the scanning electrodes 23, while the second spacers 50 abut against the front substrate 10 through the getter layer 16, conductive thin film 15, and phosphor screen 12. Thus, the spacers 30 support the front substrate 10 and the rear substrate 20 against the atmospheric pressure.

According to the SED constructed in this manner, the rear substrate 20 and the front substrate 10 are baked at 300° C. or more for degassing after the structures including the grid 18, spacers 30, etc. are previously fixed and bonded to the rear substrate 20 in manufacturing processes. In joining the rear substrate 20 and the front substrate 10 together by the sidewall 8 after the baking, the rear substrate 20 and the front substrate 10 are externally heated by a heater. Thus, in these manufacturing processes, the rear substrate 20, to which the grid 18 and other structures are fixed, and the front substrate 10 become hotter than these structures.

Further, the many electron emitting elements 27 on the rear substrate 20 generate heat as they emit electrons toward the phosphor layers during the operation of the SED. Accordingly, the temperature of the rear substrate 20 increases so that it is hotter than the structures including the grid 18, spacers 30, etc.

Thus, during the manufacture or operation of the SED, the rear substrate 20 becomes hotter than the structures fixed to the rear substrate, e.g., the grid 18. In some cases, a temperature difference of tens of degrees may be caused between these elements. According to the SED of the present embodiment, however, the grid 18 has a thermal expansion coefficient higher than that of the insulating substrate 22 of the rear substrate 20 to which the grid is fixed. If the temperature of the insulating substrate 22 becomes higher than that of the grid 18 during the manufacture or operation, therefore, the thermal expansion of the insulating substrate 22 cannot be greater than the thermal expansion of the grid. Accordingly, no tensile force is generated in the grid 18, so that the joint between the grid 18 and the insulating substrate 22, that is, the welded joints between the grid 18 and the pedestals 60 or joints between the pedestals 60 and the insulating substrate 22, can be securely prevented from being separated or damaged. Thus, manufacturing failure can be prevented to improve the yield of production, and an SED with improved reliability can be obtained.

The description of the above embodiment is focused on the grid 18, among other structures that are arranged between the front substrate 10 and the rear substrate 20 and fixed to at least one of these substrates. In the present invention, however, the structures include distributing wires for the scanning electrodes, signal electrodes, etc. and the spacers, as well as the grid 18.

More specifically, in the embodiment described above, the scanning electrodes 23 and the signal electrodes 24 are formed on the insulating substrate 22 of the rear substrate 20, that is, they are fixed on the insulating substrate 22. Like the aforesaid grid 18, therefore, the scanning electrodes 23 and the signal electrodes 24 are formed of a material that has a thermal expansion coefficient higher than the thermal expansion coefficient of the insulating substrate 22, and are given a thermal expansion characteristic such that their elongation rate is higher than that of the insulating substrate 22 at any temperature. Thus, no tensile force acts on the scanning electrodes and the signal electrodes during the manufacture and operation, so that the scanning electrodes and the signal electrodes can be prevented from being separated or disconnected.

Likewise, the spacers are formed of a material that has a thermal expansion coefficient higher than the thermal expansion coefficient of the front substrate 10 or the rear substrate 20 and are given the same thermal expansion characteristic as aforesaid. Thus, the joints between the spacers and the rear substrate and/or the joints between the spacers and the front substrate can be prevented from being separated or damaged. Outstanding functions and effects can be obtained if the spacers used are elongate ones that extend, for example, between two opposite sides of the vacuum envelope, in particular.

The following is a description of a suitable range of the thermal expansion coefficient difference. Let it be supposed that the temperature at which no tensile force is generated at the joints when the respective temperatures of the structures and the substrates are equal is Tf. If the structures are fixed without being subjected to any tensile force, Tf is the temperature at fixing. If the thermal expansion coefficient and temperature of the structures are as and Ts, respectively, and if the thermal expansion coefficient and temperature of the substrates that are fixed with the structures are αp and Tp, respectively, a tensile force is generated at the joints of the structures in a condition given by

αs(Ts−Tf)≦α(Tp−Tf) or

αs/αp≦(Tp−Tf)/(Ts−Tf)

If the left and right sides of this expression are k and Q, respectively, we obtain

k≦Q.

The value of Q varies depending on the manufacturing conditions and operating conditions. Actually, the respective temperatures of the structures and the substrates are not uniform, and have internal distributions. Further, the possibility of the joints being disengaged also depends on the fixing strength of the joints.

If k is too high, on the other hand, no tensile force is generated. However, the problem of deflection of the structures that is attributable to the thermal expansion difference is aroused.

Accordingly, the allowable value for k cannot be simply obtained, and it can be settled as a result of examination in a manufacturing apparatus that is intended for mass production of display apparatuses designed in consideration of utility.

This examination led to a result that

1.07≦k≦1.15

could be given for the grid. When k was smaller than 1.05, it was hard to avoid the problem that the joints could be disengaged by a temperature difference that would inevitably be caused in the manufacturing stage. When k was greater than 1.15, on the other hand, it was hard to avoid the problem of deflection of the grid and its positional accuracy affected by an increase of the respective temperatures of the grid and the rear substrate.

When the allowable range for k was estimated for the structures at large without regard to conditions proper to the above examination,

1.02≦k≦1.2

was obtained.

This invention is not limited to the embodiment described above, and that various modifications may be effected therein without departing from the scope of the invention. For example, this invention is also applicable to an FED that uses electron emitting elements of the field-emission type and any other flat image display apparatuses than an SED. Further, the grid may be joined to the front substrate as well as to the rear substrate. Furthermore, the dimensions, materials, etc. of the individual components are not limited to the values and materials described in connection with the foregoing embodiment, and may be selected variously as required.

What is claimed is:

1. An image display apparatus comprising:
a vacuum envelope having a first substrate and a second substrate opposed to each other with a gap;
a structure arranged between the first substrate and the second substrate and fixed to at least one of the first and second substrates;
an image display surface formed on an inner surface of one of the first and second substrates; and
a plurality of electron emitting elements which are arranged on an inner surface of the other of the first and second substrates and emit electrons toward the image display surface,
the structure having a thermal expansion coefficient higher than that of the at least one substrate to which the structure is fixed.

2. An image display apparatus according to claim 1, wherein the structure has a thermal expansion coefficient 1.02 to 1.2 times as high as the thermal expansion coefficient of the at least one substrate.

3. An image display apparatus according to claim 2, wherein the structure has a thermal expansion coefficient 1.07 to 1.15 times as high as the thermal expansion coefficient of the at least one substrate.

4. An image display apparatus according to claim 1, wherein the structure includes a plate-like grid located between the first substrate and the second substrate and opposed to the first and second substrates.

5. An image display apparatus according to claim 1, wherein the structure includes a plurality of support members which are arranged between the first substrate and the second substrate and support the first and second substrates against the atmospheric pressure.

6. An image display apparatus according to claim 1, wherein the structure has a thermal expansion characteristic such that an elongation rate thereof is higher than that of the at least one substrate at any temperature.

7. An image display apparatus comprising:
a front substrate having an image display surface formed on an inner surface thereof;
a rear substrate opposed to the image display surface with a gap and having thereon a plurality of electron emitting elements which emit electrons to the image display surface; and
a plate-like grid located between the front substrate and the rear substrate so as to opposite to the front substrate and the rear substrate and fixed to the rear substrate,
the grid having a thermal expansion coefficient higher than that of the rear substrate.

8. An image display apparatus according to claim 7, which further comprises a plurality of support members which are arranged between the front substrate and the rear substrate and support the front substrate and the rear against the atmospheric pressure, each of the support members abutting against the rear substrate and having a thermal expansion coefficient higher than that of the rear substrate.

9. An image display apparatus according to claim 8, wherein the support members are fixed to the grid.

10. An image display apparatus according to claim 7, wherein the grid has a thermal expansion coefficient 1.02 to 1.2 times as high as the thermal expansion coefficient of the rear substrate.

11. An image display apparatus according to claim 10, wherein the grid has a thermal expansion coefficient 1.07 to 1.15 times as high as the thermal expansion coefficient of the rear substrate.

12. An image display apparatus according to claim 7, wherein the grid is provided with a plurality of joints fixed to the rear substrate through pedestals, individually.

13. An image display apparatus according to claim 12, which further comprises a power supply terminal provided on an outer surface of the rear substrate, and wherein the grid has electrical conductivity and is connected electrically to the power supply terminal through at least on of the pedestals and a through hole in the rear substrate.
